(19) United States
(12) Patent Application Publication
(10) Pub. No.: US 2011/0281125 A1
(43) Pub. Date: Nov. 17, 2011

(54) BIODEGRADABLE POLYMER ARTICLES CONTAINING OXYGEN SCAVENGER

(75) Inventors: Chieh-Chun Chau, Victor, NY (US); Thomas H. Powers, Mayville, NY (US); Stanislav Solovyov, Getzville, NY (US)

(73) Assignee: Multisorb Technologies, Inc., Buffalo, NY (US)

(21) Appl. No.: 12/778,703

(22) Filed: May 12, 2010

(51) Int. Cl. B32B 27/08; B32B 15/09; C09K 3/00

(52) U.S. Cl. 428/458; 252/188.28; 428/483

(57) ABSTRACT

The invention provides a biodegradable oxygen absorbing plastic comprising a biodegradable substrate a sufficient concentration of reduced iron particles to adsorb oxygen in significant quantities and reduce the deformation temperature of the substrate substantially below the deformation temperature without iron particles present.

### STATEMENT REGARDING FEDERALLY SPONSORED RESEARCH OR DEVELOPMENT

None

### REFERENCE TO A “SEQUENCE LISTING”

None.

### TECHNICAL FIELD

This invention relates generally to oxygen scavengers and more particularly to a biodegradable polymer containing oxygen scavenger and a method for making it.

### BACKGROUND OF THE INVENTION

There is an increasing demand for polymers made from renewable resources for use in the packaging industry. As customers become increasingly conscious of the effect of polymers on the environment they demand that their products are packaged in containers made from renewable resources.

Common biodegradable polymers such as polylactic acid (PLA) are useful in many packaging applications but they have higher gas permeation properties than polyolefins and are therefore less useful in packaging products that degrade in the presence of oxygen, carbon dioxide, and water Weber among other gases.

There is a need for biodegradable polymers that can be used for packaging such degradable products. More specifically there is a need for PLA rigid packaging that provides an effective barrier to oxygen for applications such as beverage containers.

Flexible packaging materials made from PLA also exhibit relatively higher oxygen permeability that other flexible films and there is a need for flexible PLA films having reduced oxygen permeability.

PLA is known to have a relatively low heat compared with other plastic products. This can cause problems if containers made from PLA are stored in warehouses where the temperature may exceed the softening temperature (approximately 65° C.) of PLA.

U.S. Pat. No. 6,908,652B1, Cryovac, Jun. 21, 2005, “Polylactic acid in oxygen scavenging article”, describes articles consisting of PLA and oxygen scavengers selected from the group consisting of oxidizable compounds and transition metal catalyst, ethylenically unsaturated hydrocarbons and a transition metal catalyst, ascorbate, isoascorbate, sulfite, ascorbate with a transition metal catalyst with the catalyst comprising of a simple metal or salt, a compound, complex or chelate of the transition metal, a transition metal complex or chelate of a polycarboxylic acid, salicylic acid or polyamine; and tannin. The articles can be in the form of film, coating, liner and other format.

This patent does not include iron in its reduced format as oxygen scavengers that are used without in connection with other materials. Iron is not a compound and it is not to be used with a catalyst or the compounds as described in this prior art.

This patent also stated that incorporating inorganic powders and/or salts causes degradation of wall's transparency and mechanical properties. The compounds can lead to processing difficulties especially in the fabrication of thin films or thin layers within the film structure. Contrary to U.S. Pat. No. 6,908,652, the instant invention demonstrates that thin PLA films were produced by using the iron-based oxygen scavengers. Thin films, 3 mil, have good clarity and mechanical strength without processing difficulties were generated as shown in the Examples below. The key is in properly dispersing the iron-based oxygen scavengers from the compounding to film extrusion steps. Dispersion is much improved by keeping the compounds dry throughout processing. Dispersion is enhanced by treating the oxygen scavenger with lubricants or surfactants as described in U.S. patent application Ser. No. 12/416,685, filed Apr. 1, 2009, that teaches making oxygen scavenging films. The film was extruded from a mixture of 17/3/80 ratio of iron, sodium chloride and low density polyethylene. The film can be a single or multilayer structure by itself with oxygen scavenger located in any layer of the film.

U.S. Pat. No. 7,615,183, Plastics suppliers, Nov. 10, 2009, “PLA blown film and methods of making”, describes process to make blown PLA films with no mention of oxygen scavenging.

U.S. Pat. No. 7,368,160B2, Biax International, May 6, 2008, “Packaging film”, surface modified PLA film in coextrusion with reduced COF, no mentioning of oxygen scavenging.

### BRIEF DESCRIPTION OF THE INVENTION

The invention provides a biodegradable oxygen absorbing plastic comprising a biodegradable substrate a sufficient concentration of reduced iron particles to adsorb oxygen in significant quantities and reduce the deformation temperature of the substrate substantially below the deformation temperature without iron particles present.

### BRIEF DESCRIPTION OF THE DRAWINGS

FIG. 1 is a diagram in cross-section of an embodiment of this invention useful as a lidding material;

FIG. 2 is a diagram in cross-section of an embodiment of this invention useful in forming thermoformed containers;

FIG. 3 is a graphical representation showing the rate of oxygen absorption within a bag in accordance with this invention.

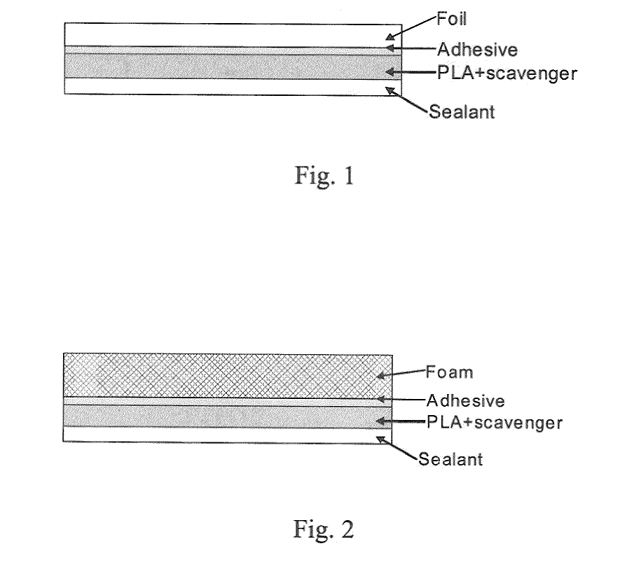

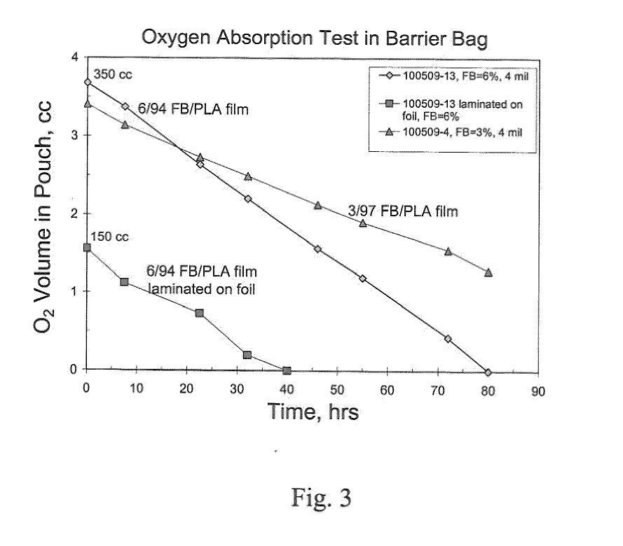

### SUMMARY OF THE INVENTION

It is an objective this invention to provide a biodegradable polymeric material that contains an oxygen scavenger that overcomes the disadvantages of the prior art.

It is a further object of this invention to provide a polylactic acide (PLA)-based oxygen scavenger having higher clarity than those scavengers heretofore known.

It is yet another object of this invention to provide a PLA-based oxygen scavenger with improved heat distortion characteristics compared with PLA materials heretofore known.

[It is a further object of this invention to provide a method for manufacturing extruded article of PLA and an iron-based scavenger.

It is a still further object of this invention to provide oxygen scavenging PLA extruded articles in the form of films and sheets that are characterized by high clarity.

It is yet another object of this invention to provide a multiple layer laminated structure formed from a foil layer, adhesive layer, a layer of PLA with an iron-based oxygen absorber, and the sealant layer that can be converted to a pouches for packaging oxygen sensitive materials.

It is a still further object of this invention to provide a multilayer laminated structure formed from a conventional polystyrene foam sheet, adhesive layer, a layer of PLA +, and a sealant layer. Preferably the laminate is thermoformable to form containers of a desired configuration.

### DETAILED DESCRIPTION OF THE INVENTION

The preferred ranges of materials, formulation, and product structures are as follows:

Oxygen Scavenger:

The reduced iron powder preferably has 1-25 um mean particle size, more preferably 1-10 um mean and most preferably 2-5 um mean. The combination and relative fraction of activating and acidifying components coated onto the iron particles are selected according to the teachings of U.S. Pat. No. 6,899,822, US Pat. applications 2005/0205841 and 2007/020456, incorporated herein by reference. The coating technique is preferably a dry coating as described in the references above.

Biodegradable Resin:

The main polymer disclosed in the invention is polylactic acid and its copolymers or derivatives with various lactide contents. The derivatives are branched PLA or lightly cross-linked PLA. The PLA can be amorphous or crystalline. Other biodegradable polymers claimed in this invention included polyhydroxyalkanoates (PHA) aliphatic co-polyesters, and its common type polymer of polyhydroxybutyrate (PHB), polycaprolactone, thermoplastic starches (TPS), cellulose and other polysaccharides. All can have their crystallinity varied to a broad range to result in various physical properties.

The following examples are used to illustrate some parts of the invention:

### Example 1

### Extrusion of PLA Films Containing Iron as Oxygen Scavenger

NatureWorks PLA2002D resin, poylactic acid, was dried in a desiccant oven at 60 C for 4 hrs. Iron, NaCl and NaHSO4 were mixed with a weight ratio of Fe/NaCl/NaHSO4=85/3/12 by following the procedure described in U.S. Pat. No. 6,899,822, US Pat. applications 2005/0205841 and 2007/020456 to form FB. The mixture, FreshBlend (FB), was blended with the PLA resin with various ratios and extruded in a twin screw extruder at an average extruder and die temperature of 220 C. The extruded film was collected by using a winder to make films of 5″ wide and approximately 4 mil thick. The extruded films were used for oxygen scavenging test. The films were stored in a 7″×7″ plastic barrier bags with the enclosure of wet felt papers as moisture source. The bags were sealed and injected with 350 or 150 cc of O2/N2 mixture to achieve a starting oxygen concentration of approximately 1%. The oxygen concentration inside the bags was measured by MOCON Pac Check Model 450 Head Space Analyzer over time at room temperature.

The oxygen scavenging behavior is shown in FIG.-3 for 3% and 6% loadings of FreshBlend in PLA. It can be seen that the oxygen volume inside the bag decreased rapidly with time. The 6% loaded film showed a higher oxygen scavenging rate than the 3% loaded film. Both showed consistent oxygen scavenging properties in PLA matrix. Both films showed high clarity as compared to the neat PLA films of the same gauge.

### Example 2

### PLA Laminates Containing Oxygen Scavenger

FIG. 2 shows a laminate in accordance with this invention. The 6% FB loaded PLA film made in Example 1 was used for lamination to foil. Dow Integral™ 801 film was used as adhesive to make a three layer laminates of the structure of Foil/Integral 801/(FB+PLA) with the thicknesses of 1/1/4 mil respectively. The three layers were heat laminated in a heat seal laminator at approximately 180° C. The laminates were formed with good bonding between the layers. The laminates were sealed in a barrier bag with 0.93 water activity moisture regulator. The oxygen scavenging behavior namely the decrease of oxygen concentration with time for FB/PLA films and laminates is shown in Figure-1 with 150 cc O2/N2 mixture and a starting concentration of 1.04% or 1.56 cc. The oxygen was depleted after 40 hours of storage. This demonstrated that the oxygen scavenging capability of the laminated structure containing FB and PLA.

### Example 3

### Coextrusion of PLA Films

The same materials were used for coextrusion of PLA in a 5-layer film structure by using a film coextrusion system. The 5 layer was arranged as A/B/C/B/A=LDPE/tie/(PLA+FB)/tie/LDPE in approximately 5/5/80/5/5 thickness ratio. The Freshblend net content was 5 wt % distributed in the C layer only. Extrusion was conducted at an average extruder exit temperatures of A=500F, B=500F and C=390F. The LDPE resin was Dow LDPE640I. The tie layer resin was Admer QF551A, maleic anhydride modified polypropylene, and PLA was NatureWorks 2002D resin. By properly adjusting the extrusion rates and the die temperature, 3 and 3.5 mil thin films were produced that consists of the five layer structure. The PLA layer that contains Freshblend was estimated in the range of 2-3 mil. This demonstrated the processability of PLA with the iron-based oxygen scavenger to form thin films in multilayer structure.

1. A biodegradable oxygen absorbing plastic comprising a biodegradable substrate a sufficient concentration of reduced iron particles to adsorb oxygen in significant quantities and reduce the deformation temperature of the substrate substantially below the deformation temperature without iron particles present.

2. The plastic of claim 1 in which the reduced iron particles have a mean particle size between about one and about 25 μm.

3. The plastic of claim 2 in which the reduced iron particles have a mean particle size between about 1 and about 10 μm

4. The plastic of claim 3 in which the reduced iron particles have a mean particle size between about 2 and about 5 μm.

5. The plastic of claim 1 in which the biodegradable substrate is selected from the group consisting of branched PLA, cross linked PLA, amorphous PLA, crystalline PLA, polyhydroxyalkanoates (PHA) aliphatic co-polyesters, polyhydroxybutyrate (PH B), polycaprolactone, thermoplastic starches (TPS), cellulose and other polysaccharides.

6. The plastic of claim 5 in which the iron particles are present in an amount of approximately 6%.

7. The plastic of claim 1 in which the plastic is in the form of a film.

8. The plastic of claim 7 also comprising a layer of foil laminated to the film.

9. The plastic of claim 7 comprising layers of low density polyethylene and adhesive laminated to the film.

10. The plastic of claim 9 in which the layers are arranged as low density polyethylene-adhesive-plastic layer-adhesive-low-density polyethylene.
